(19) United States
(12) Patent Application Publication
(10) Pub. No.: US 2011/0238796 A1
(43) Pub. Date: Sep. 29, 2011

(54) ELECTRONIC DEVICE AND METHOD

(76) Inventors: Robert L. Faulk, JR., Roseville, CA (US); Jim Hickey, North Higlands, CA (US)

(21) Appl. No.: 12/748,924

(22) Filed: Mar. 29, 2010

(51) Int. Cl. G06F 15/177; G06F 3/00; G06F 11/16

(52) U.S. Cl. 709/220; 710/47; 714/57; 714/E11.065

(57) ABSTRACT

According to one example of the present invention, there is provided an electronic device comprising one or more configurable features. The device comprises an interface for receiving configuration data for configuring a feature of the electronic device and a data store or memory for storing feature configuration data associated with a configurable feature. The device further comprises logic for determining whether the received configuration data is compatible with configuration data stored in the data store. If the logic determines that the received configuration data is compatible the device is configured in accordance with the received configuration data.

### BACKGROUND

Many electronic devices offer increasing levels of user configuration, enabling users to configure devices for their specific needs. However, many types of electronic devices are often used in conjunction with one or more other electronic devices and in order for all such devices to operate as intended it is important that the different devices be configured appropriately.

### BRIEF DESCRIPTION

Embodiments of the invention will now be described, by way of non-limiting example only, with reference to the accompanying drawings, in which:

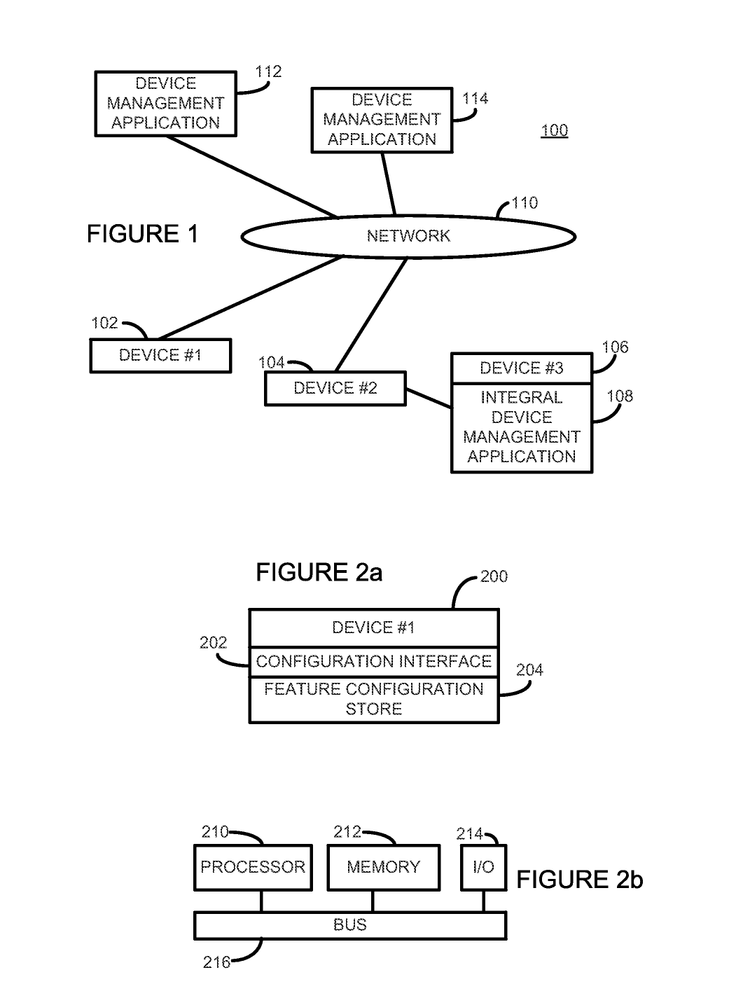

FIG. 1 is a simplified block diagram of a system according to an embodiment of the present invention;

FIG. 2a is a simplified block diagram of a device according to an embodiment of the present invention;

FIG. 2b is a simplified block diagram of a device according to an embodiment of the present invention;

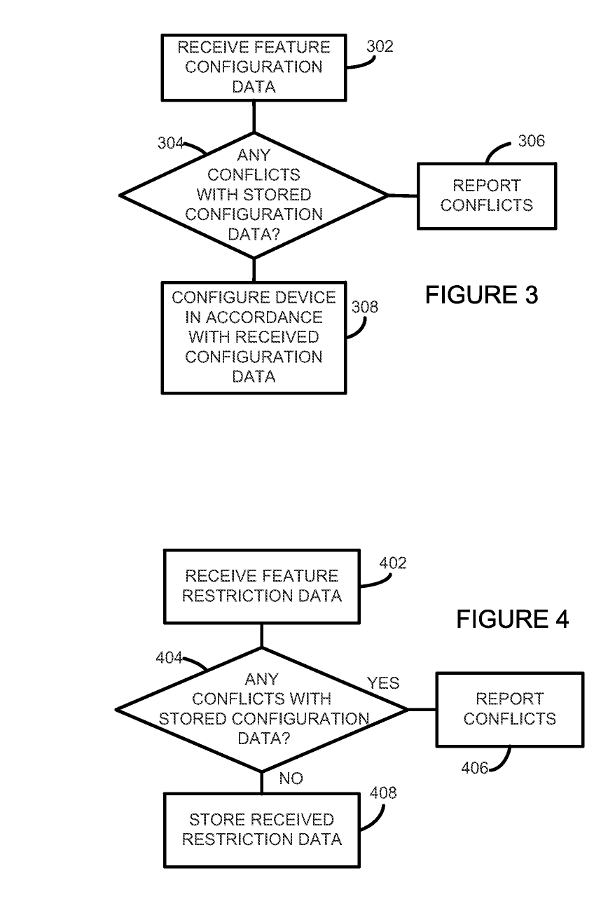

FIG. 3 is a simplified flow diagram outlining example operations performed by a device according to an embodiment of the present invention;

FIG. 4 is a simplified flow diagram outlining example operations performed by a device according to an embodiment of the present invention;

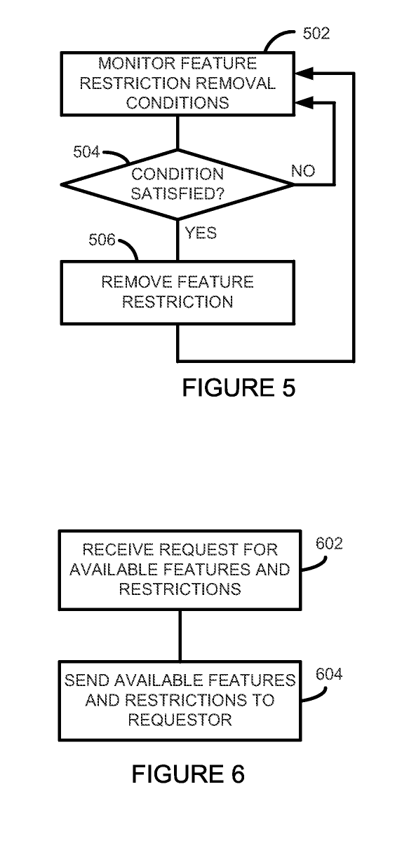

FIG. 5 is a simplified flow diagram outlining example operations performed by a device according to an embodiment of the present invention; and

FIG. 6 is a simplified flow diagram outlining example operations performed by a device according to an embodiment of the present invention.

### DETAILED DESCRIPTION

Referring now to FIG. 1 there is shown a system 100 showing a number of electronic devices 102, 104, and 106 according to an embodiment of the present invention. The electronic devices 102, 104, and 106 may be any suitable electronic devices including, but not limited to, network switches, network routers, computer servers, computing devices, storage devices, printers, mobile telephones, smart-phones, and the like.

In the current example, devices 102 and 104 are connected to a network 110, and a device 106 is connected directly to the device 104. The network 110 may be, for example, a private or a public computer network, an intranet, the public Internet, or the like.

Devices 102 and 104 each have a number of configurable features. The configurable features may include, for instance where the device is network device, security settings, port settings, VLAN settings, and the like.

The configurable features of each device 102 and 104 may be configured through a suitable configuration interface (not shown) incorporated in each device. For instance, where the devices are network devices the configuration interface may be a command line interface (CLI), a simple network management protocol (SNMP) interface, a web interface, or other suitable interface.

Configurable features of a device 102 or 104 may be configured through a suitable device management application, such as device management application 112 and 114. A device management application allows a device to be identified, for example by way of a network address, IP address, MAC address, or the like, and allows configuration data to be sent to the identified device to configure the identified device in the desired manner. Configuration data may include configuration commands.

Configurable features of a device may also, or alternatively, be configured through a device management application, such as an integral device management application 108, integral to a device such as the device 106. An integral device management application enables one device to directly configure configurable features of another device to which it is either directly or indirectly connected or coupled. Connection may be, for example, by way of a wired or wireless connection.

One of the problems, however, with such an arrangement is that a configurable device 102 or 104 within the system 100 may be configured by different device management applications 112, 114, or 108, each of which may be operated or managed by a different user. If, for example, a particular device requires that a certain other device in the network be configured in a particular manner in order to ensure the correct operation of the particular device there is no safeguard mechanism for preventing a concerned device from being configured in a manner which is incompatible with or non-desirable with respect to a different device.

Referring now to FIG. 2 there is shown a device 200 according to an embodiment of the present invention. The device 200 has a configuration interface 202 through which a set of configurable features may be configured. The device 200 comprises a data store or memory 204 for storing configuration data suitable for configuring one or more of the configurable features. As previously mentioned, if the device 200 is a network device such as a network router or network switch the configurable features may include, for example, security settings, port settings, VLAN settings, and the like. If the device 200 is a different kind of device other configurable features may apply.

Of the set of configurable features is a sub-set of restrictable features. Restrictable features are configurable features of the device 200 to which certain restrictions may be applied. In one embodiment the set of restrictable features may comprise all of the configurable features. The data store or memory 204 may also store feature restriction data relating to one or more configurable feature restrictions, as described in more detail below.

In one embodiment, the device 200 may comprise, as shown in FIG. 2b, a processor or controller 210, a memory 212, and an input/output module 214. The controller 210, the memory 212, and the input/output module 214 are coupled together via a bus 216. The memory 212 may contain computer readable instructions which, when processed by the processor 210, cause the processor 210 to perform method steps as described below, or other logical or processor-based operations. The memory 212 may additionally store configuration data, as described further below. The I/O module 214 may implement the configuration interface 202 and be configured to allow data to be received from and sent to device management applications, such as applications 112, 114, and 108. The memory 212 may comprise a single or multiple memory modules, and may comprise, for example, in one embodiment a suitable non-volatile memory device and a suitable volatile memory device.

Exemplary operation of the device 200 according to one example will now be made with further reference to the flow diagrams of FIGS. 3, 4, 5 and 6.

At block 302 the device 200 receives feature configuration data, for example, through the configuration interface 202. The feature configuration data may be received, for example, from a suitable device management application 112, 114, or 108. The feature configuration data may include, for example, device programming instructions, CLI instructions, SNMP instructions, or any other data suitable for configuring, or for causing to be configured, a configurable feature of the device 200.

At 304, the received feature configuration data is checked against any currently stored configuration data stored in the data store or memory 204 to ensure that the received feature configuration data is not in conflict with any previously stored feature configuration data. If no conflicts are determined the device is configured (308) in accordance with the received configuration data. Configuration of the device may be achieved in any suitable manner, for example, including storing the received feature configuration data, or at least a portion thereof, in the data store or memory 204 or executing configuration instructions represented by the received feature configuration data. If, however, one or more conflicts are determined details of those conflicts, or at least an error message, are reported (306) to the device management application having sent the feature configuration data. The error message may, for example, include a textual message stored in the feature configuration data store 204, as described below.

For instance, if the device 200 receiving the feature configuration data is a network switch, a system administrator may have stored a set of feature configuration data in the switch to restrict, for example, port security on the switch from being used. If a device which later connects to the switch tries to configure the switch to use port security this incompatibility will be detected, and configuration of the switch that is incompatible with any stored feature configuration data will be prevented.

Exemplary operation of the device 200 in accordance with a further example will now be described with further reference to FIG. 4.

At block 402 the device 200 receives feature restriction data from a device management application 108, 112 or 114. In some embodiments the feature restriction data may be received separately from feature configuration data, and in some embodiments the feature restriction data may be received together with feature configuration data. At 404 the device 200 checks the received feature restriction data against any feature configuration data stored in the data store or memory 204 to ensure that any feature restrictions that the device 106 wishes to place on the device 200 are compatible with any configuration data, including any feature restriction data, currently stored in the data store or memory 204. If it is determined that there is a conflict then details of the conflict, or at least an error message, is sent (406) to the device management application 106. If the stored feature restriction data includes a textual message, the textual message may be reported in place of, or in addition to, any error message. If there are no conflicts the received feature restriction data is stored (408) in the feature configuration data store or memory 204.

In a further example, at 402 the device 200 receives feature restriction data that includes feature restriction removal data. Feature restriction removal data defines, for example, one or more determinable conditions of the device 200, or of any other device to which the device 200 is connected. Upon detection of such a condition the associated or related configured feature restriction may removed or deleted from the feature configuration memory or data store 204.

For example, if the device 200 is a network switch, example feature restriction removal conditions may include: remove an identified feature restriction after the switch is rebooted; remove an identified feature restriction when a predetermined VLAN is deleted; and remove an identified feature restriction after a predetermined time and date.

FIG. 5 shows an exemplary operation of feature restriction removal monitor process performed by the device 200. At 502 any feature restriction removal conditions stored in the feature configuration data store or memory 204 are monitored. In one embodiment the monitoring may be performed, for example, by interrogating or polling a status indicator, status data, a flag, or a memory address, etc. of an appropriate device. The interrogating or polling may, for instance, be performed at regular predetermined time intervals, or at any other suitable interval. At 504, if none of the conditions are satisfied the logic returns to 502 to continue monitoring. If, at 504, it is determined that a feature restriction removal condition is satisfied or has occurred the corresponding feature restriction data and associated feature restriction removal data is removed (506) from the feature configuration memory or data store 210. In a further embodiment a feature restriction removal condition may be detected by, for example, by detecting a processor interrupt triggered when a defined condition is met. In a yet further embodiment a state machine implementation may be used.

In a further embodiment, to assist other users of the network 100, a feature configuration report may be obtained by sending an appropriate request from a device management application to a device, for example through the configuration interface 202, as described in relation to FIG. 6.

At 602 the device 200 receives, for example from a device management application 112, 114, or 108, a request to receive details of the feature configuration data stored in the data store or memory 204. At 604 the device 200 obtains the requested information from the feature configuration memory or data store 204 and sends the obtained information in a suitable format to the device making the request. A suitable format may include, for example, an XML, text-based format, human-readable, or machine-readable format. The obtained information from the feature configuration memory or data store 210 may include feature configuration data, feature restriction data, and feature restriction removal data.

Such a system is particularly beneficial in systems where multiple devices are present and which may be configured by different users. In large systems a user may not be aware of who configured a particular device in a particular manner and it may be difficult to establish whether any particular feature restrictions need to be maintained. In the above-described examples, details of any configured feature restrictions may be obtained directly from the device concerned and the details may include information about who made the configuration and the reason why.

Furthermore, if feature restriction removal conditions are used this helps ensure that feature restrictions are removed automatically when no longer required. Furthermore, if an application or device attempts to configure a device in a manner incompatible with stored configuration data the application attempting the configuration is informed in a useful manner of the nature of the restriction.

Exemplary operation of the system is further described below. In this example the device 200 is a network device.

The feature configuration data store 204 of device 200 stores details of a number of device features which are configurable along with any associated configuration data. Table 1 below shows an example of feature configuration data stored in data store 204.

TABLE 1
EXAMPLE FEATURE CONFIGURATION DATA

| FEATURE IDENTIFIER | CONFIGURATION DATA | |
|---|---|---|
| 802.1X Port Security | Enabled | Ports 1, 2, 3, 4 |
| IP Address | 15.29.1.1 | VLAN 2 |
| VLANS | Enabled | VLAN 2 |
| VLANS | Enabled | VLAN 5 |
| . . . | . . . | |

The feature configuration data store 204 stores, for example, a feature identifier to identify a particular feature, and one or more items of configuration data. As shown in Table 1 the feature ‘802.1x Port Security’ has been configured with configuration data which enables port security on ports 1, 2, 3, and 4. Although the data in the tables herein is shown in human readable form the data may be stored in machine readable form in other embodiments.

The feature configuration data store also stores, for example, feature restriction data, an example of which is shown in Table 2.

TABLE 2
Example Feature Restriction Data
FEATURE RESTRICTION DATA

| | |
|---|---|
| Application Name | HP Firewall+, Slot A |
| Imposing restriction | |
| Feature ID to be restricted | VLAN_DELETION |
| Feature Name to be restricted | “VLAN_DELETION” |
| VLANS with restriction | 5 |
| Ports with restriction | N/A |
| Error Message | “Please remove security |
| | policies from HP Firewall+ |
| | in slot A before deleting |
| | this VLAN” |
| Feature Restriction Removal | EXPIRE_ON_SLOT_DOWN |
| Condition(s) | EXPIRE_ON_REBOOT |

Although in the above tables the configuration data and feature restriction data are separately, the configuration data and feature restriction may equally be stored or represented in a single data structure, container, or other suitable element.

As can be seen from table 2, the device management application imposing the restriction is identified as “HP Firewall+, Slot A”. This information helps other devices determine who or what has imposed feature restrictions on a device. The identifier of the feature to be restriction is “VLAN_DETECTION”, and a textual identifier of “VLAN_DELETION” is used in reporting the feature name restricted to a device management application. The VLAN with the restriction is VLAN number 5. An error message to be returned to a device management application trying to configure the device in a manner which is incompatible with the imposed restriction is also stored. This textual message is intended to help a user of a device management application understand why a particular restriction is in place.

A number of feature restriction removal conditions are also stored which are in this example ‘EXPIRE_ON_SLOT_DOWN’ and ‘EXPIRE_ON_REBOOT’. If the device 200 detects (502, 504) that either the slot A has gone down or is not responding, or if the device 200 is rebooted, the device 200 will remove (506) the associated feature restriction.

If a device management application, such as device management application 112 wishes to configure a feature of the device 200 it sends appropriate configuration data thereto. The device 200 receives (302) the configuration data and determines (304) whether there are any conflicts with any feature configuration data stored, such as the feature restriction data stored in Table 2.

The presence of a conflict may be determined, for instance, in any appropriate manner. For example, presence of a conflict may be determined by identifying a configurable feature to which the received configuration data relates. This may be achieved, for example, by identifying configurable features using a predetermined identifier and by searching the stored configuration data to determine whether any feature restrictions apply to that identified feature. Any suitable search or look-up type functions may be used.

If no conflicts are determined (404), the received configuration data is stored (408) in the feature configuration data store 204. Otherwise an error is reported (406) to the device management application.

For example, if the device management application 112 wishes to delete VLAN 5 it sends appropriate configuration data to the device 200. The device 200 receives (302) the configuration data and determines (304) that the stored feature restriction data (for example as shown in Table 2) prevents VLAN 5 from being deleted. The device 200 then obtains from the stored feature restriction data the error message associated with the feature restriction data, and sends the error message to the device management application 112. In this example the text “Please remove security policies from HP Firewall+ in slot A before deleting this VLAN” is sent to the device management application 112. In a further embodiment the error message may additionally include, for example, the name, identifier, or contact details, of the user or application that imposed the restriction.

At 502 the device 200 monitors the feature restriction removal conditions defined in the stored configuration data. If at 504 it is determined that slot A on the device 200 has gone done or has otherwise stopped responding, the associated feature restriction (i.e. ‘VLAN Deletion’) data is removed from the feature configuration memory 204, thereby enabling VLANs to be deleted by other device management applications.

It will be appreciated that not all of the above-described steps are required in all of the embodiments.

It will also be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape, or other computer readable medium. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. An electronic device comprising one or more configurable features, the device comprising:
an interface for receiving configuration data for configuring a feature of the electronic device;
a data store for storing feature restriction data associated with a configurable feature;
logic for determining whether the received configuration data is compatible with stored feature restriction data, and where it is so determined, configuring the device in accordance with the received configuration data.

2. The device of claim 1, wherein the logic is further configured to, where it is determined that the received configuration data is not compatible with stored feature restriction data stored in the data store, to report an error to the sender of the received configuration data.

3. The device of claim 1, wherein the step of configuring the device in accordance with the received configuration data comprises storing the received configuration data in the data store.

4. The device of claim 1, wherein the interface is configured to receive configuration data comprising feature restriction data associated with a feature, the logic being configured to: determine whether the received feature restriction data is compatible with configuration data stored in association with the feature, and where it is so determined, storing the feature restriction data.

5. The device of claim 4, wherein the logic is further configured to, where it is determined that the received feature restriction data is not compatible with the stored configuration data, to obtain a textual message stored in association with the determined incompatible configuration data, and to send the obtained textual message to the sender of the received feature restriction data.

6. The device of claim 4, wherein the interface is configured to receive feature restriction data comprising feature restriction removal data associated with a feature and to store the received feature restriction removal data in association with an associated feature restriction data.

7. The device of claim 6, wherein the logic is further configured to remove feature restriction data associated with a feature from the data store when it is determined that a condition defined by stored feature restriction removal data associated with that feature has occurred.

8. The device of claim 1, wherein the interface is configured to receive a request to supply stored configuration data, wherein the logic is further configured to obtain, from the data store, stored configuration data, and to send the obtained configuration data to the requestor, wherein the obtained configuration data includes at least one of: feature configuration data, feature restriction data, and feature restriction removal data.

9. The device of claim 1, wherein the device is a network device, wherein the interface is a simple network management protocol SNMP, and wherein the interface is configured to receive configuration data relating to features including at least one of virtual LAN configuration, port configuration, security configuration, and connection configuration.

10. A method of controlling the configuration of an electronic device comprising:
receiving device configuration data;
determining whether the received configuration data is in conflict with feature restriction data stored on the device; and
configuring the device in accordance with the received configuration data where it is determined that there is no conflict; and
reporting a message to the sender of the received configuration data where it is determined that there is a conflict.

11. The method of claim 10, wherein the received configuration data comprises configuration instructions, the step of configuring the device comprises executing the received configuration instructions on the device.

12. The method of claim 10, wherein the step of configuring the device in accordance with the received configuration data comprises storing the configuration data in a memory in the device.

13. The method of claim 10, further comprising monitoring feature restriction removal data stored on the device to determine when a condition thereby defined is satisfied, and where it is so determined, deleting associated feature restriction data from the device.

14. The method of claim 13, wherein the step of monitoring feature restriction removal data comprises at least one of: polling a status indicator of a device, and detecting an interrupt.

15. A computer readable medium having embodied thereon computer readable code which, when executed, performs a method of controlling an electronic device, the method comprising:
receiving configuration data for configuring a feature of the electronic device, the configuration data comprising at least one of feature configuration data, feature restriction data, and feature restriction removal data;
determining whether the received configuration data is not in conflict with feature configuration data or feature restriction data stored on the device, and
where it is not so determined, configuring the device in accordance with the received configuration data; and
where it is so determined, obtaining an error message stored in association with the conflicting feature restriction data and sending the obtained error message to the sender of the received configuration data.
